(19) United States
(12) Patent Application Publication
(10) Pub. No.: US 2013/0009944 A1
(43) Pub. Date: Jan. 10, 2013

(54) 3D computer graphics object and method

(75) Inventor: Markus Moenig, Suratthani (TH)

(73) Assignee: BrainDistrict

(21) Appl. No.: 13/135,467

(22) Filed: Jul. 6, 2011

(51) Int. Cl. G06T 15/00

(52) U.S. Cl. 345/419

(57) ABSTRACT

A graphical object template associates multiple human language attributes each with a subset of the defined numerical values associated with at least one of the numerical value data fields. The graphical object template provides the same to virtual reality (VR) software and thus allows for automatic interpretation of a fuzzy definition of a component of a new VR scene.

### BACKGROUND OF THE INVENTION

The invention relates to defining a virtual reality (VR) scene such as through the use of related software (VR software). Defining a VR scene includes defining three-dimensional graphical objects and positioning the graphical objects into the (initially empty) VR scene by setting coordinates i.e. distances in relation to axes of a three-dimensional coordinate system of the scene or to a previously defined point of reference and angles of rotation about the axes.

A three-dimensional graphical object to be used in defining a VR scene either is a primitive, for example, a single point, a line, a circle, a triangle or another open or closed polygon, a spline curve or a spline surface, a surface defined by a cloud of points or by extrusion of a curve or polygon, or a sphere or cylinder. Each three-dimensional graphical object includes at least one single primitive and optionally includes features, for example, physical surface and volume properties like color, brightness, reflectivity, translucency, weight and elasticity, and further optionally includes relations i.e. distances and rotations in relation to a local coordinate system or to a point of reference that is defined in the object. A three-dimensional graphical object may include further primitives and relations, for example, distances and angles of rotation in relation to other primitives that are included in the graphical object. The features and relations defining the graphical object are associated with numerical value data.

A graphical object may further have a human language name, for example, a “tree”, “wall” or “gate”. Features as well may be assigned human language attributes, for example, common color names like “yellow” or predefined surface patterns like “red brick” or “rusty iron”.

The invention further relates to a three-dimensional graphical object template, to be used in defining a VR scene. A graphical object template is a graphical object definition, wherein at least one of the features and relations used for determining a graphical object is initially undefined, but defined when using the template, thus creating a (completely defined) graphical object.

The invention further relates to a database for managing graphical objects and templates for defining a VR scene using VR software. Predefined graphical objects and object templates are often provided to the VR software by databases from networked database servers over the internet.

The invention further relates to a method for defining a graphical object while defining a VR scene from within VR software, making use of such a graphical object template from such a database. The VR software either has internal search facilities for finding graphical objects and templates by specifying their respective human language names, or makes use of external search interfaces, in particular provided by the database servers.

Specifications for defining new VR scenes are often provided fuzzily in natural language, with components such as “A wooden house overlooking a hill” or “A roman temple overlooking the sea” or even “London, 18^{th} century”. However, in commonly known methods and VR software, for defining a single three-dimensional graphical object of a new VR scene, the related features and relations must be assigned exact values. The creator of the new VR scene thus must manually select numerical values for features and relations for a multitude of objects from, for example, “tree” or “house” templates and one by one position the same into the scene.

### SUMMARY OF THE INVENTION

According to the invention, a graphical object template implemented on a computer system that processes a source software application includes a graphical object template including primitives having features, relations among the primitives, numerical value data fields associated with the features and the relations, sets of defined numerical values associated with the numerical value data fields, at least one human language object name, and a plurality of human language attributes, wherein each of the plurality of human language attributes is associated with at least one subset of the defined numerical values.

Providing a subset of values, the graphical object can be fuzzily defined by selecting the subset rather than specifying one of the values out of the subset. Having a human language attribute associated with the subset allows for identifying the subset by specifying the attribute.

Semantic analysis software is identifies nouns, related attributes and relations of nouns within a human language stream, such as a written or spoken prose text. Each noun, its related attributes and relations can be easily written to a separate data structure defining an object. Such semantic analysis of a human language description of a scene and the resulting object definition data, inside VR software can serve for fuzzily pre-setting VR objects for a VR scene.

Specifying numerical values within the selected subsets, thus completing the object setting process for the fuzzily pre-set VR object can be done by random selection or by selecting a default value provided for the subset within the template.

In an exemplary embodiment of the invention, the primitives of the graphical object template include triangles, polygons and clouds of points. Basically any three-dimensional object surface may be represented by triangles, by extrusion of polygons or by a cloud of points.

In a further exemplary embodiment of the invention, the features of the graphical object template include dimensions and orientations in space, and surface and volume properties of the primitives. Attributes relating to subsets of dimensions are, for example, “large” and “small”, attributes relating to subsets of orientation in space are, for example, “near” and “far”, attributes relating to subsets of surface properties are, for example, names of basic colors and brightness attributes, for example, “dark” and “bright”. Any such attributes may in addition be defined by relation to another object such as “smaller than” and “darker than”.

In a further exemplary embodiment of the invention, the relations of the graphical object template include distances in space among the primitives.

In a further exemplary embodiment of the invention, within the graphical object template at least one of the plurality of human language attributes is associated with multiple data fields, and with their associated subsets of defined values, respectively. Attributes relating to multiple data fields may be used to define complex graphical objects, for example, the attribute “large” defined for an object “house” may define intervals for overall dimensions in three directions in space.

In a further exemplary embodiment of the invention, the graphical object template includes at least one default numerical value for one of the plurality of human language attributes. Using templates including default values, graphical objects may be automatically defined without explicitly defining a related attribute, for example, a “house” (with no attribute defined) may by default be created as a standard two-floor one-family dwelling, having a porch in the front.

Further according to the invention, a database is provided for managing the above mentioned graphical object templates. Managing graphical object templates in databases provides the opportunity to enhance the definition process of a VR scene by attaching another or further database, and to offer such templates with minimum effort such as on one single server to be accessed over a network by multiple users of the VR software.

In an exemplary embodiment of the invention, within the database at least one of the human language attributes is associated with a plurality of graphical object templates. Associating one attribute with a plurality of templates provides for grouping templates in a human language definition, for example “An 18^{th} century church and farmer's market”, where templates “church” and “farmer's market” both have an attribute “18^{th} century”, each specifying subsets of values associated with features and relations of primitives or of at least less complex objects contained in the related template.

Further according to the invention, a method for defining a graphical object comprises the steps of using a graphical object template including primitives having features, relations among the primitives, numerical value data fields associated with the features and the relations, sets of defined numerical values associated with the numerical value data fields, at least one human language object name, and a plurality of human language attributes, wherein each of the plurality of human language attributes is associated with at least one subset of the defined numerical values, and submitting to a database the human language object name of the graphical object template and one of the plurality of human language attributes, wherein the features associated with the submitted human language attribute, and the associated numerical value data fields, respectively, are automatically selected from within associated subsets of defined numerical values. Initial effort for defining a graphical object according to the invention thus is limited to submitting in human language both the human language name of the object template and the human language attribute to the VR software. The VR software automatically selects specific numerical values and sets the same for the features associated with the attribute, within the subset defined by the attribute, and creates the object using these specific values.

In an exemplary embodiment of the invention, within the method at least one of the defined numerical values is set to a default numerical value in the template. In an alternative embodiment of the invention, within the method the graphical object template further includes at least one randomly generated numerical value for one of the plurality of human language attributes. For example, a “house with windows” could randomly define “windows” as two to four windows. Alternatively, the generated numerical value could be determined by the context such as the number of windows could be a random range determined by the size of the house. For example, two or three windows for a small sized house, two to four windows for a medium sized house and four to ten windows for a large house. Alternatively, the random numerical value can be weighted by the attribute. For example, “tree” which could use a weighted probability set for the type of tree such as 70% oak, 25% pine, and 5% spruce and the random number defining the which type of tree.

Further according to the invention, a method for defining a scene includes the steps of defining graphical objects using the above method for defining a graphical object, and positioning the graphical objects into a virtual reality scene, wherein multiple of the definitions of graphical objects and relations between the graphical objects are read from one complex human sentence having at least subject and object, using a language analyzing software. Making use of language analyzing software provides the opportunity of automatically reading human language prose text, or analyzing spoken human language, and to automatically define a VR scene accordingly—quite similar to the process of individually imagining a scene while reading a book or listening to story.

In an exemplary embodiment of the invention, a position of at least one of the graphical objects is determined by an attribute defining a relation to at least one other graphical object or to a point of reference defined in the scene. Attributes defining relations in space among objects are, for example, “behind” and “in front of”, “next to”, “left to” or “right to”, “above” or “below”. Points of reference by default defined for a new scene are, for example, “foreground”, “middle” and “background”, “left periphery” and “right periphery”, “floor”, “subsoil” and “sky”.

In an exemplary embodiment of the invention, within the method the distances between the graphical objects are automatically set as to avoid overlapping of the graphical objects. Avoiding overlap of graphical objects utilizes an “inside” of the related objects to be defined, applying commonly known mathematical methods, and providing rules for adjustment, such as translational displacement of objects. Adjustment in particular can be selected within the limits of previously selected attributes and related subsets of numerical values.

### BRIEF DESCRIPTION OF THE DRAWINGS

The invention will be described in detail with reference to the following drawings in which like reference numerals refer to like elements wherein:

FIG. 1 illustrates the structure of an exemplary VR software;

FIG. 2 illustrates a UML activity diagram of a method for defining a VR scene according to the invention is provided; and

FIG. 3 and FIG. 4 illustrates detailed UML activity diagrams of the natural language analysis and of the VR object setting activities executed within the method according to the invention.

In the figures, rounded rectangles represent activities, other boxes (here: angular boxes, circles and cylinders) represent data containers, and arrows represent data flow.

### DETAILED DESCRIPTION

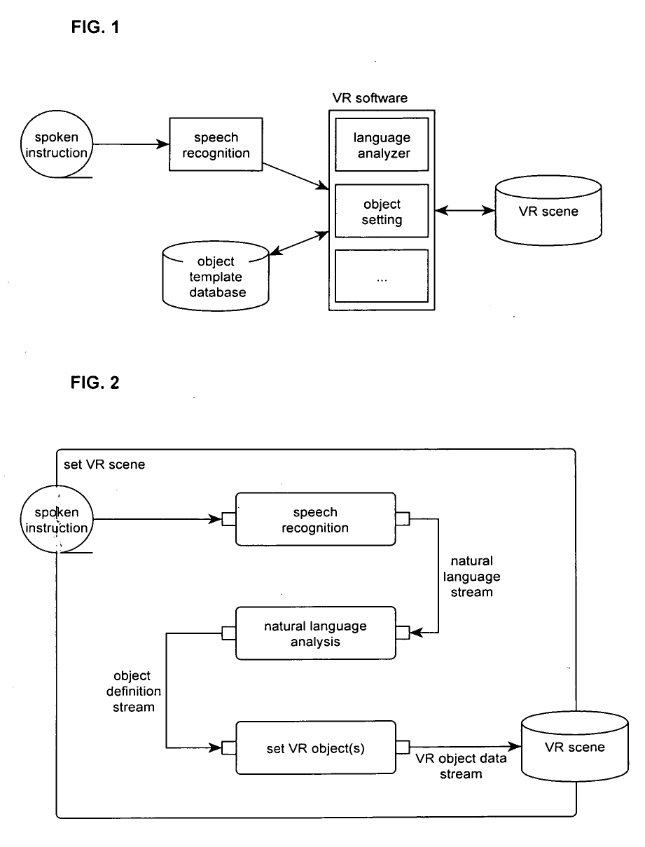

According to FIG. 1, an exemplary inventive VR software 1 for creating, editing and/or manipulating a new or pre-existing VR scene 2 has a language analyzer module 3 for analyzing a natural language stream 4 of data, an object setting module 5 for setting VR object data 6 and is connected to an object template database 7 over the internet. Prior to the inventive VR software 1, a separate standard speech recognition software 8 is used for converting a record of a spoken instruction 9 into the natural language stream 4.

In an exemplary VR scene 2 setting process, for creating the VR scene 2, the VR software 1 provides an initially empty data container. The container has a global coordinate system with x-, y- and z-axes, wherein the x-axis represents direction “east”, y-axis represents direction “south”, negative x- and y-axes represent directions “west” and “north”, z-axis represents the height of a point in space and the origin defines a point in space named “center” as well as a “floor level”. A global point light source is initially included at infinity in z-direction.

According to FIG. 2, the spoken instruction 9 for creating the VR scene 2 is provided to the speech recognition software 8, which creates and forwards the natural language stream 4 of data to the VR software 1. The spoken instruction 9 and the resulting natural language stream 4 as an example contains a description of a scene inside a house. An exemplary sentence of the natural language stream 4 defines “a chamber with a door in the left wall and a back wall made of glass”. The language analyzer module 3 does a natural language analysis 10 of the natural language stream 4 and provides a resulting object definition stream 11 to the object setting module 5 of the VR software 1. The object setting module 5 executes a VR object setting process 12 and sends an object data stream 13 to the container of the VR scene 2.

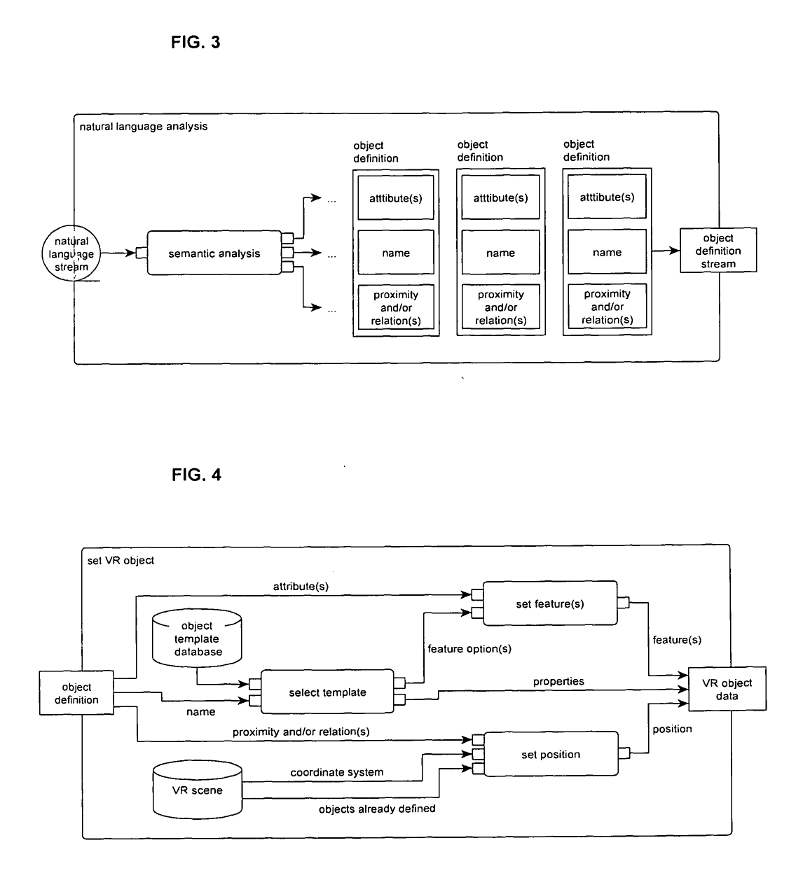

According to FIG. 3, the language analyzer does a semantic analysis 14 and identifies semantic elements and structure of the natural language stream 4. For each new noun, language analyzer initializes an internal data structure representing a new VR object definition 15 and assigns the noun as name 16 of a VR object, then further identifies attributes 17 related to the objects and relations 18, in particular proximities 19 between the objects and adds both to the respective object definitions 15. For the exemplary sentence mentioned above, the natural language analyzer selects nouns “chamber”, “door” and “wall” from the natural language stream 4 and assigns them as names 16 to three object definitions 15. The natural language analyzer then selects an attribute 17 “made of glass” and assigns the same to one of the “wall” object definitions 15. The natural language analyzer further selects positions 20 “left” and “back” and assigns them to the respective “wall” object definitions 15. Last, the natural language analyzer selects relations 18 “with” and “in” and accordingly subordinates the “wall” objects to the “chamber” object and the “door” object to the “left wall” object. The data structures representing the single object definitions 15 are streamed, for example in XML file format, to the object setting module 5 of the VR software 1.

According to FIG. 4, the object setting module 5 of the VR software 1 reads the single object definitions 15 from the object definition stream 11. For each object definition 15, the object setting module 5 executes a template selection routine 21 and queries the object template database 7 for a template being assigned the name 16 mentioned in the respective object definition 15 and initializes an internal data structure representing new VR object data 6 according to the template returned from the database. For the exemplary sentence mentioned above, the object setting module 5 identifies a name 16 “chamber” and queries the template database 7 for a template being assigned the name 16 “chamber”.

Within the template database 7, a template “room” recognizes the name 16 “chamber” to be an equivalent name 16 for a “small room” and the template database 7 returns to the template selection routine 21 the template “room”, pre-set with an attribute 17 “small”. The “room” template, as any template, has a local coordinate system. It has a cuboid shape with a “floor” plane in the first quadrant of the x-y-plane, four “wall” planes and a “top” plane parallel to the “floor” plane, all in the first octant of the local coordinate system. A first “wall” plane in the first quadrant of the x-z-plane has assigned the attributes 17 “north”, a second “wall” plane in the first quadrant of the y-z-plane has assigned the attribute 17 “west” and the two further “wall” planes parallel to the latter have assigned attributes 17 “south” and “east”. The template selection routine 21 initially writes these properties 22 to the internal data structure representing the object data 6 of a new VR object “room” and sends feature setting requests for any undefined feature of the “room” object.

For each feature setting request, the object setting module 5 executes a feature setting routine 23 and queries the respective object definition 15 for attributes 17 and either matches the request to an attribute 17 or further queries the respective templates for default values and forwards the resulting features 24 to the internal data structure representing the new object data 6. For the exemplary sentence mentioned above, the “wall”, “floor” and “top” planes refer to a further object template “plane” within the template database 7 and have attributes 17 “height”, “width” and “material” as well as optional features 24 “door” and “window”, again referring to respective further object templates. The “door” object associated with the “west wall” is randomly set to a simple white door of 2×0.90 m with frosted metal fittings.

No height and width being explicitly defined within the object definition 15, the feature setting routine 23 queries for default values set in the respective templates. The attribute 17 “small” defines a “room” object to have a floor area of 4 to 12 square meters and height of 2 m to 2.5 m. No defaults given in the template, the feature setting routine 23 randomly sets the “room” object to a width of 3.5 m, 2.5 m depth and 2.20 m height. According to the attribute 17 “made of glass”, the feature setting routine 23 randomly selects from the glass materials provided in the database the “north wall” to be translucent glass bricks. No material given for the other walls in the object definition 15, the feature setting routine 23 sets these to “plastered, antique white” according to a default defined for the “wall” and “top” objects, and to “parquet flooring” for the “floor” object.

Within the object setting process 12, the position 20 of any new object is set by a position setting routine 25, which reads proximities 19 and relations 18 from the object definition 15 and refers to information on coordinate systems 26 and on objects 27 that were previously defined in the respective VR scene 2. For the exemplary sentence mentioned above, the position setting routine 25 recognizes attributes 17 “left” and “back” associated to the respective wall objects to be equivalent to “west” and “north”. No further attributes 17 or relations 18 being set for the “room” object, the template selection routine 21 accordingly matches the template's local coordinate system with the global coordinate system 26 of the VR scene 2. The position setting routine 25 further by default sets the door in the west wall at a golden ratio position 20.

In the figures, items are numbered as follows:
1 software
2 scene
3 language analyzer module
4 natural language stream
5 object setting module
6 object data
7 template database
8 speech recognition software
9 spoken instruction
10 natural language analysis
11 object definition stream
12 object setting
13 object data stream
14 semantic analysis
15 object definition
16 name
17 attribute
18 relation
19 proximity
20 position
21 template selection
22 property
23 feature setting
24 feature
25 position setting
26 coordinate system information
27 object information

What is claimed is:

1. A graphical object template implemented on a computer system that processes a source software application, comprising:
a graphical object template including:
primitives having features;
relations among the primitives;
numerical value data fields associated with the features and the relations;
sets of defined numerical values associated with the numerical value data fields;
at least one human language object name; and
a plurality of human language attributes,
wherein each of the plurality of human language attributes is associated with one subset of the defined numerical values.

2. The graphical object template of claim 1, wherein the primitives include triangles, polygons and clouds of points.

3. The graphical object template of claim 1, wherein the features include dimensions and orientations in space, and surface and volume properties of the primitives.

4. The graphical object template of claim 1, wherein the relations include distances in space among the primitives.

5. The graphical object template of claim 1, wherein at least one of the plurality of human language attributes is associated with multiple data fields, and with their associated subsets of defined values, respectively.

6. The graphical object template of claim 1, comprising:
at least one default numerical value for one of the plurality of human language attributes.

7. A database for managing the graphical object templates of claim 1.

8. The database of claim 7, wherein at least one of the human language attributes is associated with a plurality of graphical object templates.

9. A method for defining a graphical object, comprising the steps of:
using a graphical object template including:
primitives having features;
relations among the primitives;
numerical value data fields associated with the features and the relations;
sets of defined numerical values associated with the numerical value data fields;
at least one human language object name; and
a plurality of human language attributes,
wherein each of the plurality of human language attributes is associated with one subset of the defined numerical values, and
submitting to a database the human language object name of the graphical object template and one of the plurality of human language attributes,
wherein the features associated with the submitted human language attribute, and the associated numerical value data fields, respectively, are automatically selected from within associated subsets of defined numerical values.

10. The method of claim 9, wherein at least one of the defined numerical values is set to a default numerical value in the template.

11. The method of claim 9, wherein the graphical object template further includes at least one randomly generated numerical value for one of the plurality of human language attributes.

12. A method for defining a scene, comprising the steps of:
defining graphical objects using the method of claim 9, and
positioning the graphical objects into a virtual reality scene,
wherein multiple of the definitions of graphical objects and relations between the graphical objects are read from one complex human sentence having at least subject and object, using a language analyzing software.

13. The method of claim 12, wherein a position of at least one of the graphical objects is determined by an attribute defining a relation to at least one other graphical objects or to a point of reference defined in the scene.

14. The method of claim 12, wherein the distances between the graphical objects are automatically set as to avoid overlapping of the graphical objects.
